(19) United States
(12) Patent Application Publication
(10) Pub. No.: US 2008/0126991 A1
(43) Pub. Date: May 29, 2008

(54) MOBILE TERMINAL AND METHOD FOR ALERTING A USER OF SCHEDULE INFORMATION

(75) Inventors: Hee Hyun KANG, Gumi-si (KR); Jae Wan PARK, Gumi-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/940,722

(22) Filed: Nov. 15, 2007

(30) Foreign Application Priority Data
Nov. 28, 2006 (KR) 10-2006-0118203

(51) Int. Cl. G06F 3/048

(52) U.S. Cl. 715/835

(57) ABSTRACT

A mobile terminal and a method for scheduling in the mobile terminal are provided. The method includes displaying a schedule information input screen in response to a schedule information setting request signal; inputting schedule information through the displayed input screen, and storing the input schedule information. The schedule information includes icon selection information and an icon display time period.

### CROSS REFERENCE TO RELATED APPLICATION

This application claims priority from and the benefit of Korean Patent Application No. 10-2006-0118203, filed on Nov. 28, 2006, which is hereby incorporated by reference for all purposes as if fully set forth herein.

### BACKGROUND OF THE INVENTION

1. Field of the Invention

The present invention relates to a mobile terminal and a method for alerting a user of schedule information, and more particularly, to a mobile terminal for alerting a user of preset schedule information and a method thereof.

2. Discussion of the Background

Due to the development of manufacturing technologies for mobile terminals, mobile terminal manufacturing companies now provide various functions to satisfy various needs of users (for example, an alarm watch, a schedule alarm service, a camera, and an MP3 player).

A schedule alarm service provides an alarm when a scheduled alarm time point arrives. The schedule alarm time point may be the time of a specific event (for example, a morning call, a conference, or a birthday).

However, when schedule information is set in a conventional schedule alarm service, the user may need to directly input an event content (for example, “wedding anniversary” or “meeting”) that should be performed at a specific time point.

Also, when the scheduled alarm time arrives, the event content may be exposed to another person because a preset event content is displayed in a form of a pop-up window on a screen.

Further, in order to check the event content, the user may need to enter a menu that provides a schedule information check function to check the event content.

### SUMMARY OF THE INVENTION

The present invention provides a mobile terminal and a method that may efficiently and conveniently alert a user of schedule information stored in the mobile terminal.

The present invention further provides a mobile terminal and a method that may allow a user to easily set schedule information and be alerted of schedule information.

The present invention further provides a mobile terminal and a method that may prevent schedule information from being exposed to another person.

The present invention further provides a mobile terminal and a method that may not require a user to enter and check a schedule information check menu in order to check the content of an event.

Additional features of the invention will be set forth in the description which follows, and in part will be apparent from the description, or may be learned by practice of the invention.

The present invention discloses a method for scheduling in a mobile terminal including displaying a schedule information input screen in response to a schedule information setting request signal, inputting schedule information through the displayed information input screen, and storing the input schedule information. The schedule information includes icon selection information and an icon display time period.

The present invention also discloses a mobile terminal including a display unit to display a schedule information setting screen and an icon, an input unit to input schedule information containing icon selection information and an icon display time period a storage unit to store the input schedule information, and a controller to control the display unit to display the icon when a current time point is within the icon display time period.

The present invention also discloses a method for scheduling in a mobile terminal including inputting schedule information. Inputting schedule information includes inputting an event time point, an event content, and an alarm method, selecting an icon, and inputting an icon display period. The icon is displayed during the icon display period and the event content is displayed if the icon is selected during the icon display period. The event content is displayed at the event point time while an alarm is output using the alarm method.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram showing a configuration of a mobile terminal according to an exemplary embodiment of the present invention.

FIG. 2 is a flowchart showing a process of setting schedule information in a method according to an exemplary embodiment of the present invention.

FIG. 3 is a flowchart showing a process of alerting to schedule information in a method of alerting to schedule information according to an exemplary embodiment of the present invention.

FIG. 4 shows an example of a screen according to the process of setting schedule information of FIG. 2.

FIG. 5A and FIG. 5B show examples of a screen according to the process of alerting to schedule information of FIG. 3.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

A mobile terminal according to exemplary embodiments of the present invention is any device that can perform a schedule information alarm service, such as a mobile communication terminal, a mobile phone, a Personal Digital Assistant (PDA), a smart phone, a Digital Multimedia Broadcasting (DMB) phone, an MP3 player, a notebook computer, an audio appliance, a portable television, and a digital camera, and applications thereof.

In exemplary embodiments of the present invention, ‘schedule information’ is information that may be stored in a mobile terminal, which alerts a user of an event at a set time. The ‘schedule information’ includes icon selection information and an icon display time period. An ‘event content’ refers to a detailed description of the event. An ‘icon display time period’ indicates a time period during which an icon for displaying the event content is displayed on a screen of the mobile terminal. The icon display time period can be set using an icon display start time point (for example, 7:00 AM, November 5) and an icon display termination time point (for example, 6:00 PM, November 6).

The mobile terminal in which the icon display time period is set may display a preset icon for 35 hours from 7:00 AM, November 5 to 6:00 PM, November 6.

The schedule information may further include input information (for example, an event time point, an event content, an event period, and an alarm method).

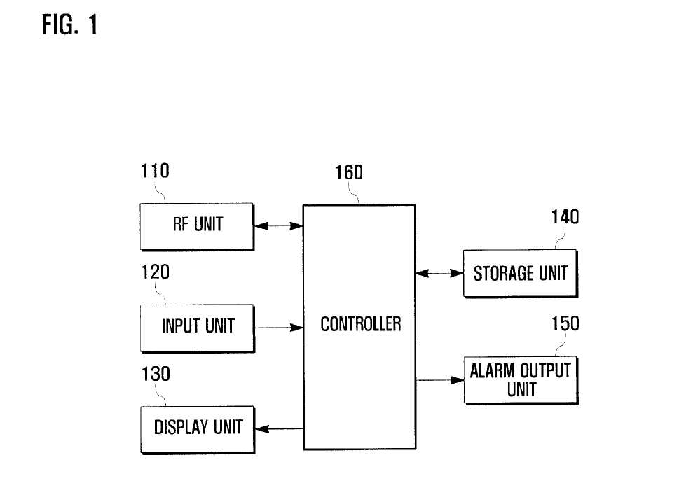

FIG. 1 is a block diagram showing the configuration of a mobile terminal according to an exemplary embodiment of the present invention.

Referring to FIG. 1, the mobile terminal includes a radio frequency (RF) unit 110, an input unit 120, a display unit 130, a storage unit 140, an alarm output unit 150, and a controller 160.

The RF unit 110 includes an RF transmitter to up-convert a frequency of a signal to be transmitted and amplify the signal and an RF receiver to low-noise amplify a received signal and down-convert a frequency of the signal. The RF unit 110 transmits and receives data through a wireless communication network.

The input unit 120 may include a touch pad or a key pad, which may have various function keys, numeric keys, special keys, and character keys, and outputs a signal input by a user to the controller 160 to control operation of the mobile terminal. Particularly, the input unit 120 receives schedule information containing icon selection information and an icon display time period from the user and outputs the information to the controller 160. The input unit 120 receives an icon selection signal input by the user to select an icon displayed in the display unit 130 and outputs the icon selection signal to the controller 160.

The display unit 130 may be a liquid crystal display (LCD) and displays various display data generated in the mobile terminal and an operating state of the mobile terminal on a screen. Particularly, the display unit 130 displays a schedule information input screen. The display unit 130 also displays a preset icon on the screen during an icon display time period. When the mobile terminal includes a touch screen, the display unit 130 may also perform an input function.

The storage unit 140 stores programs and data required to perform general operations of the mobile terminal. Particularly, the storage unit 140 stores schedule information containing icon selection information, an icon display time period, and an event content input through the input unit 120. The storage unit 140 stores icon information. The icon information is a stored icon image matched to icon selection information and may be downloaded from an external source or stored in the storage unit 140 when the mobile terminal is manufactured.

The controller 160 controls alarm output unit 150 to generate an alarm with a preset alarm output method at a preset alarm output time point. Particularly, the alarm output unit 150 may be any of a speaker, a vibration generator, and a lamp.

The controller 160 performs general control operations of the mobile terminal. Particularly, when schedule information containing icon selection information, an icon display time period, and an event content is input to the mobile terminal, the controller 160 controls the display unit 130 to display an icon corresponding to the icon selection information during the icon display time period. If the icon selection signal is input when an icon is displayed, the controller 160 controls the display unit 130 to display an event content corresponding to the icon.

The controller 160 controls the alarm output unit 150 to generate an alarm with a preset alarm output method at a preset alarm output time point.

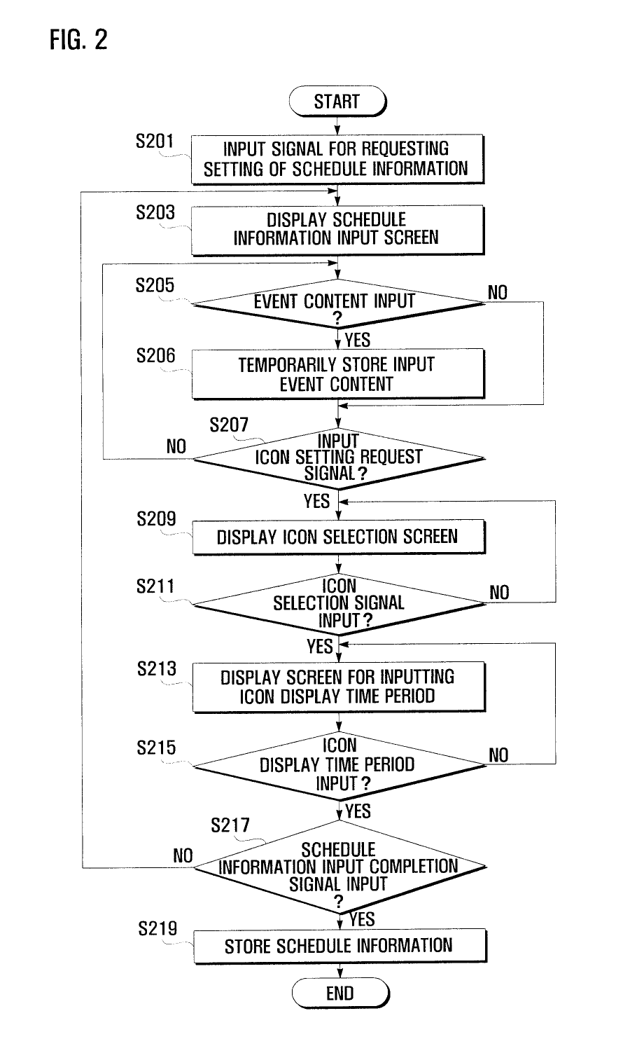

FIG. 2 is a flowchart showing a process of setting schedule information in a method according to an exemplary embodiment of the present invention.

Referring to FIG. 1 and FIG. 2, when a signal requesting setting of schedule information is input through the input unit 120 (S201), the controller 160 controls the display unit 130 to display a schedule information input screen (S203). The schedule information input screen may include a screen for inputting an event content, icon selection information, and an icon display time period.

The controller 160 determines whether an event content has been input through the displayed schedule information input screen (S205). If an event content has been input through the displayed schedule information input screen, the controller 160 controls the storage unit 140 to temporarily store the input event content (S206). If an event content has not been input through the displayed schedule information input screen, the controller 160 determines whether an icon setting request signal is input through the input unit 120 (S207).

After the input event content is temporarily stored at step S206, the controller 160 determines whether an icon setting request signal is input through the input unit 120 (S207). The icon setting request signal is a signal requesting setting of an icon for displaying the event content that is input at step S205.

When the icon setting request signal is input, the controller 160 controls the display unit 130 to display an icon selection screen (S209). The icon selection screen may display all icons stored in the storage unit 140 of the mobile terminal so that a user may select an appropriate icon for displaying an event content. If the icon setting request signal is not input, the process returns to step S205.

The controller 160 determines whether an icon selection signal has been input through the displayed icon selection screen (S211). If an icon selection signal is not input through the displayed icon selection screen, the process returns to step S209 and the controller 160 continues to control the display unit 130 to display the icon selection screen. If an icon selection signal is input through the displayed icon selection screen, the controller 160 controls the display unit 130 to display an icon display time period input screen (S213).

The controller 160 determines whether an icon display time period has been input (S215). If an icon display time period has not been input, the process returns to step S213 and the display unit 130 continues to display the icon display time period input screen. If an icon display time period has been input, the controller 160 determines whether a schedule information input completion signal has been input (S217).

If a schedule information input completion signal has not been input, the process returns to step S203 and the controller 160 adjusts the input schedule information according to further user input. If a schedule information input completion signal has been input, the controller 160 creates a database containing the input schedule information and controls the storage unit 140 to store the database (S219). The setting process of the schedule information is thereby completed.

In the description of the setting process of FIG. 2, for convenience of description, an exemplary embodiment of a method of setting schedule information containing an event content, icon selection information, and an icon display time period is described, however the present invention is not limited to this exemplary embodiment. The schedule information may further include, for example, an event time point, an event period, and an alarm method.

Setting the schedule information may be performed by sequentially inputting and storing an event content, a selection of an icon, and an input of an icon display time period. However, the items of schedule information may be stored in an order different from that in which the items of schedule information are input.

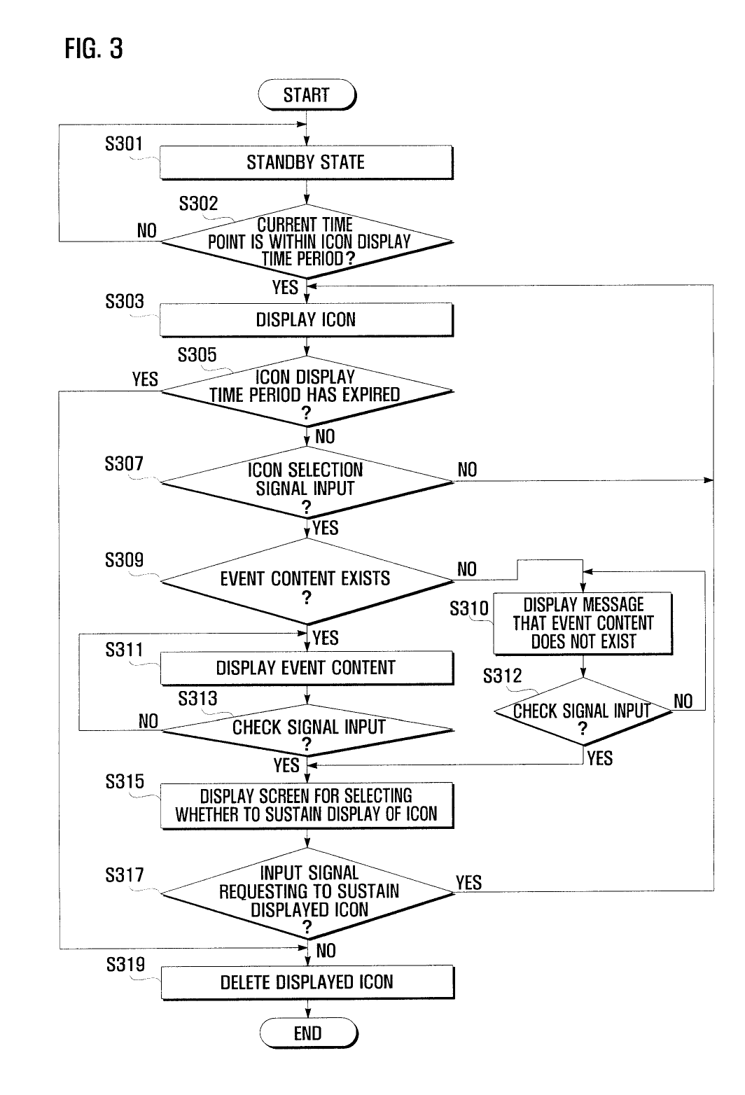

FIG. 3 is a flowchart showing a method for alerting a user of schedule information according to an exemplary embodiment of the present invention.

Referring to FIG. 1 and FIG. 3, when the mobile terminal is in a standby state (S301), the controller 160 determines whether the current time is within an icon display time period included in the schedule information (S302).

If the current time is within the icon display time period, the controller 160 controls the display unit 130 to display an icon according to the schedule information (S303). If the current time is not within the icon display time period, the process returns to step S301 and the mobile terminal remains in the standby state.

The controller 160 determines whether the icon display time period has expired (S305).

If the icon display time period has expired, the displayed icon is deleted (S319). If the icon display time period has not expired, the controller 160 determines whether an icon selection signal for the icon displayed in the display unit 130 has been input (S307).

If an icon selection signal has not been input, the process returns to step S303 and the controller 160 continues to control the display unit 130 to display the icon according to the schedule information. If an icon selection signal is input, the controller 160 determines whether an event content corresponding to the icon exists (S309).

If an event content corresponding to the icon does not exist, the controller 160 controls the display unit 130 to display a message that an event content does not exist (S310). The controller 160 determines whether a check signal, which confirms that the message displayed in the display unit 130 has been seen by the user, has been input (S312). If a check signal has been input, the process continues at step S315, which is discussed below. If a check signal has not been input, the process returns to step S310 and the display unit 130 continues to display the message.

If an event content corresponding to the icon exists at step S309, the controller 160 controls the display unit 130 to display the event content (S311).

The controller 160 determines whether a check signal, which confirms that the event content displayed in the display unit 130 has been seen by the user, has been input (S313). If a check signal has not been input, the process returns to step S311 and the controller 160 continues to control the display unit 130 to display the event content. If a check signal for the event content has been input, or if a check signal for the displayed message has been input at step S312, the controller 160 controls the display unit 130 to display a screen for selecting whether to sustain display of the displayed icon (S315).

The controller 160 determines whether a signal requesting sustained display of the displayed icon has been input by the user (S317). If a signal requesting sustained display of the displayed icon has been input, the process returns to step S303 and the controller 160 continues to control the display unit 130 to display the icon according to the schedule information. If a signal requesting sustained display of the displayed icon has not been input, the controller 160 deletes the displayed icon (S319).

In the description of FIG. 3, for the convenience of description, an exemplary embodiment of a method of alerting a user of schedule information including icon selection information, an icon display time period, and an event content is described. However the present invention is not limited to the exemplary embodiment. The schedule information may further include, for example, an event time point, an event period, and an alarm method.

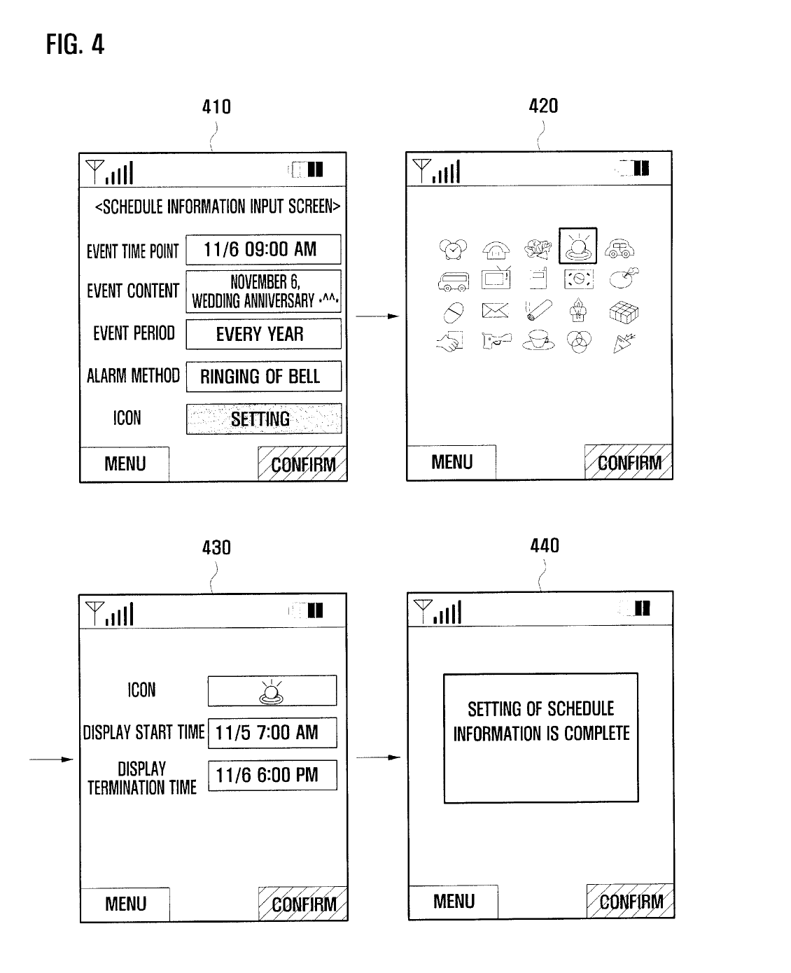

FIG. 4 shows an example of a screen according to the process of setting schedule information of FIG. 2.

Referring to FIG. 1 and FIG. 4, when a signal requesting setting of schedule information is input by the user, the controller 160 controls the display unit 130 to display a schedule information input screen 410. The schedule information input screen 410 may include menu options such as ‘event time point’, ‘event content’, ‘event period’, ‘alarm method’, and ‘icon’.

When the schedule information is stored in the mobile terminal, the controller 160 alerts a user of an event content (for example, November 6, wedding anniversary *̂̂*) at an event time point (for example, 9:00 AM, November 6) with a preset alarm method (for example, ringing of a bell) at a preset event period (for example, every year). The ‘icon’ menu option is an icon displaying a meaning of the event content (for example, November 6, wedding anniversary *̂̂*). After the ‘event time point’, ‘event content’, ‘event period’, and ‘alarm method’ are input, when an icon setting request signal for an icon included in an ‘icon’ menu is input (for example, ‘setting’ and input of a ‘confirmation key’), the controller 160 controls the display unit 130 to display an icon selection screen 420 for selecting an icon expressing the event content.

If an icon for displaying an event content of “November 6, wedding anniversary *̂̂*” is selected on the icon selection screen 420 by the user and a confirmation key is input, the controller 160 controls the display unit 130 to display an icon display time period input screen 430.

When an icon display start time point (for example, November 5, 7:00 AM) and an icon display termination time point (for example, November 6, 6:00 PM) are input by the user and a schedule information input completion signal (for example, a confirmation key) is input, as shown in the icon display time period input screen 430, the controller 160 controls the display unit 130 to display a message, which indicates that the input of schedule information has been completed, on a setting completion screen 440.

When the display start time point is reached in the exemplary embodiment of FIG. 4, the controller 160 controls the display unit 130 to display the wedding ring icon for 35 hours from 7:00 AM on November 5^{th} to 6:00 PM on November 6^{th}. When the wedding ring icon displayed in the display unit 130 is selected, a message including the event content “November 6, wedding anniversary *̂̂*” is displayed in the display unit 130. A message including “November 6, wedding anniversary *̂̂*” (i.e. the event content) and “9:00 AM, November 6” (i.e. the event time point) is displayed every year (i.e. the event period) together with the ringing of a bell (i.e. the alarm method) through the speaker SPK.

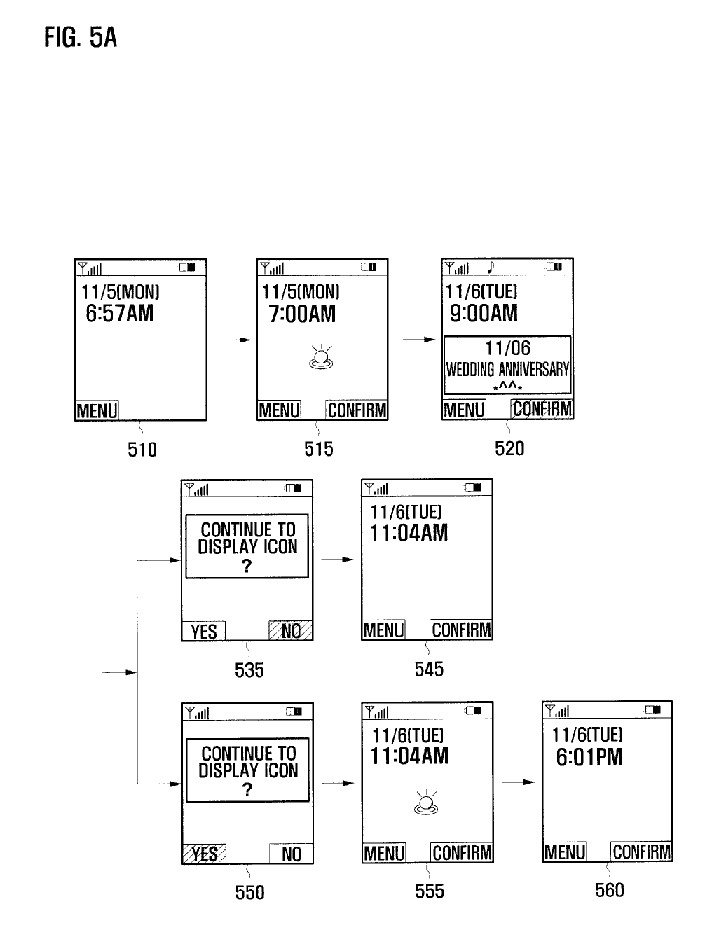

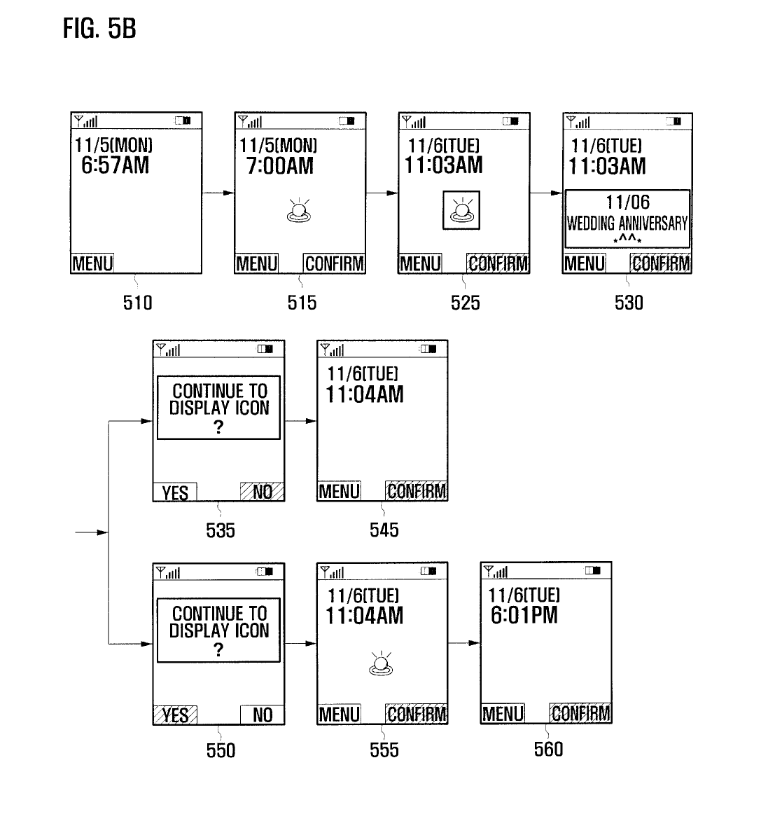

FIG. 5A and FIG. 5B show examples of a screen according to the process of alerting to schedule information of FIG. 3.

Particularly, in descriptions of FIG. 5A and FIG. 5B, a case of alerting a user of schedule information set in FIG. 4 is shown.

FIG. 5A shows a case of alerting a user to a preset event content when an event time arrives in a state where the icon set in FIG. 4 is displayed.

Screen 510 indicates the display unit 130 displaying “6:57 AM, November 5.” Because “6:57 AM, November 5” is not included in the icon display time period (from 7:00 AM, November 5 to 6:00 PM, November 6) set in the screen example of FIG. 4, an icon is not displayed.

The display unit 130 displays a wedding ring icon and “7:00 AM, November 5,” as shown in screen 515, because 7:00 AM, November 5 is within the icon display time period (from 7:00 AM, November 5 to 6:00 PM, November 6).

The mobile terminal alerts the user to the preset event content (November 6, wedding anniversary *̂̂*) at the preset event time point (9:00 AM, November 6) with a preset alarm method (ringing of a bell), as shown in screen 520. The event content may be displayed on the display unit 130 through one of an overlay display method, a pop-up window display method, and a sliding display method.

Thereafter, when a confirmation key indicating that the event content has been seen by the user is input, as shown in screen 520, the display unit 130 displays a message “Continue to display icon?”, as shown in screens 535 and 550.

If the user inputs ‘No’, as shown in screen 535, the mobile terminal deletes the wedding ring icon displayed on the display unit 130, as shown in screen 545. If the user inputs ‘Yes’, as shown in screen 550, the mobile terminal continues to display the wedding ring icon, as shown in screen 555.

When the icon display time period has expired, the mobile terminal deletes the wedding ring icon displayed on the display unit 130, as shown in screen 560.

FIG. 5B shows a case where the mobile terminal displays an event content when a displayed icon is selected by the user during the icon display time period.

Screen 510 indicates the display unit 130 displaying “6:57 AM, November 5.” Because “6:57 AM, November 5” is not within the icon display time period (from 7:00 AM, November 5 to 6:00 PM, November 6) set in the screen example of FIG. 4, an icon is not displayed.

The display unit 130 displays a wedding ring icon and “7:00 AM, November 5,” as shown in screen 515, because 7:00 AM, November 5 is within the icon display time period (from 7:00 AM, November 5 to 6:00 PM, November 6).

When the wedding ring icon is selected and a confirmation key is input by the user, as shown in screen 525, the display unit 130 displays the event content of “November 6, wedding anniversary *̂̂*”, as shown in screen 530. The event content may be displayed on the display unit 130 using one of an overlay display method, a pop-up window display method, and a sliding display method.

Thereafter, when a confirmation key indicating that the event content has been seen by the user is input, as shown in screen 530, the display unit 130 displays a message of “Continue to display icon?”, as shown in screens 535 and 550.

If the user inputs ‘No’, as shown in screen 535, the mobile terminal deletes the wedding ring icon displayed in the display unit 130, as shown in screen 545. If the user inputs ‘Yes’, as shown in screen 550, the mobile terminal continues to display the wedding ring icon, as shown in screen 555.

When the icon display time period has expired, the mobile terminal deletes the wedding ring icon displayed on the display unit 130, as shown in screen 560.

Exemplary embodiments in which an icon is displayed on the display unit 130 have been described above. However, when the current time is within more than one icon display time period, the corresponding icons may be alternately displayed at preset positions using one of a general icon display method, overlay display method, pop-up window display method, and sliding display method.

As described above, according to exemplary embodiments of the present invention, a schedule information alarm service set in a mobile terminal may be provided more efficiently and conveniently.

Schedule information can be easily stored, and a user may be easily alerted of schedule information.

It also may be possible to prevent schedule information from being exposed to another person.

Further, it may be unnecessary for a user to enter and check a schedule information check menu in order to check an event content.

It will be apparent to those skilled in the art that various modifications and variations can be made in the present invention without departing from the spirit or scope of variations of this invention provided they come within the scope of the appended claims and their equivalents.

What is claimed is:

1. A method for scheduling in a mobile terminal, comprising:
displaying a schedule information input screen in response to a schedule information setting request;
inputting schedule information through the displayed information input screen, the schedule information comprising icon selection information and an icon display time period; and
storing the input schedule information.

2. The method of claim 1, further comprising displaying an icon during the icon display time period if a current time is within the icon display time period.

3. The method of claim 1, wherein the schedule information further comprises an event content.

4. The method of claim 2, wherein displaying an icon comprises displaying at least two icons.

5. The method of claim 2, further comprising:
determining whether an event content corresponding to the selected icon exists in response to selection of the display icon; and
displaying the event content if the event content corresponding to the selected icon exists.

6. The method of claim 5, further comprising:
sustaining the display of the displayed icon in response to a request to sustain the display of the displayed icon; and
deleting the displayed icon in response to a request to not sustain the display of the displayed icon.

7. The method of claim 5, further comprising deleting the displayed icon when the icon display time period expires.

8. A mobile terminal, comprising:
a display unit to display a schedule information input screen and an icon;
an input unit to input schedule information comprising icon selection information and an icon display time period;
a storage unit to store the input schedule information; and
a controller to control the display unit to display the icon when a current time point is within the icon display time period.

9. The mobile terminal of claim 8, wherein the schedule information further comprises an event content.

10. The mobile terminal of claim 8, wherein the controller controls the display unit to display an event content corresponding to the displayed icon in response to an icon selection signal.

11. A method for scheduling in a mobile terminal, comprising:
inputting schedule information comprising:
inputting an event time point, an event content, and an alarm method,
selecting an icon, and
inputting an icon display period;
displaying the icon during the icon display period;
displaying the event content if the icon is selected during the icon display period; and
displaying the event content at the event time point while outputting an alarm using the alarm method.

12. The method of claim 11, wherein inputting the schedule information further comprises inputting an event period, and
wherein displaying the event content at the event time point while outputting an alarm using the alarm method is repeated according to the event period.

13. The method of claim 11, further comprising:
receiving a check signal confirming the display of the event content;
displaying a screen for selecting whether to sustain display of the icon;
sustaining display of the icon in response to a selection to sustain display of the icon; and
deleting the icon in response to a selection not to sustain display of the icon.

14. The method of claim 11, further comprising deleting the icon at the end of the icon display period.
